(19) United States
(12) Patent Application Publication
(10) Pub. No.: US 2010/0218515 A1
(43) Pub. Date: Sep. 2, 2010

(54) CHILLING APPARATUS

(76) Inventors: Harvey S. Fink, Bloomfield, MI (US); Lawrrence J. Nolan, Livonia, MI (US); Jerry J. Jagodmnski, Farmington Hills, MI (US)

Correspondence Address: THE WEINTRAUB GROUP, P.L.C., 28580 Orchard Lake Road, Suite 140, Farmington Hills, MI, 48334, US

(21) Appl. No.: 12/718,714

(22) Filed: Mar. 5, 2010

Related U.S. Application Data
(63) Continuation-in-part of application No. 11/895,740, filed on Aug. 27, 2007.

(51) Int. Cl. F25D 25/00; F17C 13/00; F25D 17/02

(52) U.S. Cl. 62/62; 62/457.9; 62/376

(57) ABSTRACT

An apparatus for chilling beverage containers such as bottles or cans includes a fluid tank containing chilling liquid cooled by a refrigeration unit and a membrane of collapsible thermoplastic polyurethane includes an internal chamber for supporting the container in the liquid, the membrane in the form of a shaped sleeve that surrounds the container to prevent the container coming into direct contact with the chilling liquid but which permits the liquid to transfer heat from the container to cool the contents of the container.

### CROSS-REFERENCE TO RELATED APPLICATION

This Application is a continuation-in-part of application Ser. No. 11/895,740, filed Aug. 27, 2007, the entire disclosure of which is hereby incorporated by reference.

### BACKGROUND OF THE INVENTION

1. Field of the Invention

The present invention pertains to a cooling or chilling apparatus, which in a particular but not exclusive aspect, may be applied to the chilling of beverages such as beer, wine and soda drinks in bottles or cans or other containers, but which may be applied to cooling or chilling other articles. The invention also pertains to a preformed thermoplastic polyurethane membrane for receiving and contracting into engagement with the exterior of the beverage container to transfer heat from the beverage container to a chilled fluid in the apparatus.

2. Description of the Prior Art

Beverages in containers are normally cooled in conventional refrigerators. Commercial establishments often use cold rooms, or walk-in coolers, to cool beverages as well. There is, however, usually a considerable period of time which elapses between the time at which the beverage container is placed into a refrigerator or cold room and the time at which its temperature is acceptable for drinking. More rapid cooling can be achieved by using ice which is placed in contact with the bottle. However, ice is not readily available in many situations, and additionally, it cannot be contained easily without melting. The above problems are accentuated in establishments which are involved in the supply of cold beverages such as restaurants. In these situations, it is often impossible for a large range of wines or other beverages to be stored and maintained at a low temperature for service and supply. Some arrangements have been proposed whereby bottles or other containers are placed into a container carrying a chilled liquid. However, in these arrangements the bottles or other containers become wet and therefore are not immediately suitable for use. Additionally, there is a danger that wet bottles or containers can slip from the grasp of a user. In addition, it is economically and environmentally prohibitive to chill more beverages than are necessary, and is thus desirable to chilled beverages as they are needed.

It is well known that interest in and consumption of wines has increased dramatically in recent years, to the point where the discriminating consuming public has expanded rapidly and extensively. In this context, previously known apparatuses for cooling bottles of wine have proved to be inadequate.

U.S. Pat. No. 5,845,514 to Clarke et al. describes an apparatus for cooling or chilling beverages in containers, such as a wine bottle. In this apparatus, a bag formed from a liquid-impervious material (e.g., plastic) is submerged in a solution of chilling fluid. A thin resilient U-shaped strip of plastic material is positioned in the bag and forms a support for the beverage container. The support includes a pair of sidewalls and a cross-arm. The pressure of the cooling liquid operates to collapse the bag and force the arms into engagement with the side of the bottle.

However, such an apparatus does not provide active movement of the beverage container relative to the chilling fluid, and it relies on the chilling fluid to force the closure bag against the U-shaped support. The heat transfer is not believed to be effective. First, the chilling fluid, alone, must act to press the bag against the sidewalls of the U-shaped support. Second, the fluid pressure against the bag must collapse the sidewalls of the U-shaped support inwardly and against the bottle. Third, the support member is designed to prevent a vacuum being created between the bag and the bottle to prevent the bottle from rupturing the bag during withdrawal of the bottle from the bag. The requirement that fluid pressure must force the bag and support member inwardly but that the support member prevents the bag and bottle from engaging one another to prevent the bag from rupturing during withdrawal therefrom appears to limit the rate and effectiveness of any possible heat transfer.

It is to be appreciated that a need exists for an improved apparatus for cooling and chilling beverage containers that is simple, yet rapidly effectuates the chilling process.

Accordingly, it is an object of this invention to provide an apparatus which can quickly and easily chill a container or other object.

### SUMMARY OF THE INVENTION

The present invention aims to provide, in a preferred aspect, an apparatus for cooling or chilling beverages. In particular, for cooling beverages in containers such as wine bottles, beer and soft drink bottles, cans or the like. The present invention cools the beverage in a rapid and efficient manner while maintaining the beverage container dry. The present invention, while particularly applicable to the cooling or chilling of beverages, may be used for cooling or chilling other suitable articles as well. For instance, it may be used in the medical field for rapidly chilling and cooling objects such as body organs for use in transplantation or cadaver organ donation. In addition, the present invention may be very well suited for use in the commercial food preparation industry in which pre-cooked foods, such as soup, must be quickly reduced to a low temperature from a boil before canning or bottling in order to inhibit the growth of bacteria.

A first preferred embodiment according to the present invention provides a cooling apparatus for chilling an object comprising: (a) an elongated cylindrical tube having opposed ends and an inner tubular surface, at least one of the ends being open; (b) a membrane secured about the inner tubular surface forming a sealed enclosure with the tube, the enclosure having an inlet port and an outlet port; (c) means for circulating a fluid into and out of the enclosure through the respective inlet and outlet ports; and (d) means for vibrating the object when the object is placed within the cylindrical tube.

Preferably, the membrane comprises an enclosed bladder which is secured to or about the cylindrical tube so that the cylindrical tube provides structure to the membrane. The membrane is formed from a suitable thin-walled elastomer. Even more preferably, the membrane is formed from a thermoplastic polyurethane elastomer.

Preferably, the means for vibrating comprises a vibration plate.

The means for circulating can comprises a fluid pump and a refrigeration unit in fluid communication with the enclosure. In this embodiment, the refrigeration unit is configured to cool the fluid to a set temperature, and the fluid pump is configured to pump the fluid from the refrigeration unit to the enclosure.

Optionally, the present invention can further include means for controlling which comprises components such as electrical circuitry and a timer to control the operation of the fluid pump and the means for vibrating.

The fluid is preferably selected from the group consisting of a glycol, a mixture of glycol and water, and brine.

In another aspect, the present invention provides for a method for cooling an object comprising: (a) providing a cooling apparatus, the cooling apparatus comprising an elongated cylindrical tube having opposed ends and an inner tubular surface, at least one of the ends being open, a membrane secured about the inner tubular surface forming a sealed enclosure with the tube, the enclosure having an inlet port and an outlet port, and means for vibrating the object when the object is placed within the cylindrical tube; (b) placing the object within the cylindrical tube; (c) pumping a chilled fluid through the inlet port and into the enclosure to expand and engage the membrane with the object; (d) circulating the chilled fluid through the inlet port, into the enclosure, and out through the outlet port; and (e) vibrating the object until the object attains a desired temperature.

In yet another aspect, the present invention provides a method of cooling a beverage within a container by engaging the container against a bladder filed with a chilled fluid and vibrating the beverage until the beverage attains a cooled temperature.

The means for controlling controls the temperature of the chilled fluid and includes a fluid pump and a refrigeration unit which are in fluid communication with a reservoir to pump chilling fluid from the refrigeration unit to the chilling tank and circulate and withdraw the chilled fluid from the chilling tank the temperature of which fluid is raised as a result of heat transfer between the membrane during contact with the chilled fluid circulated in the tank. The means for controlling can optionally include a thermostat to maintain the temperature of the chilling fluid in the chilling tank at a predetermined temperature. Although the temperature will depend on the application desired by the user, preferably the thermostat operates to maintain the chilling fluid at a temperature of between about −30.0° C. and 5.0° C.

According to this embodiment, the cylindrical tube, membrane, and means for vibrating are located within a housing.

The present invention will be more clearly understood with reference to the accompanying drawings and to the following detailed description, in which like reference numerals refer to like parts.

### BRIEF DESCRIPTION OF THE DRAWINGS

FIG. 1 is a perspective view of the present invention hereof;

FIG. 2 is a cut-out schematic view of the present invention; and

FIG. 3 is a cut-out view of the present invention showing a beverage container disposed therein and having the fluid-filled membrane secured against the beverage container.

### DETAILED DESCRIPTION OF THE PREFERRED EMBODIMENTS

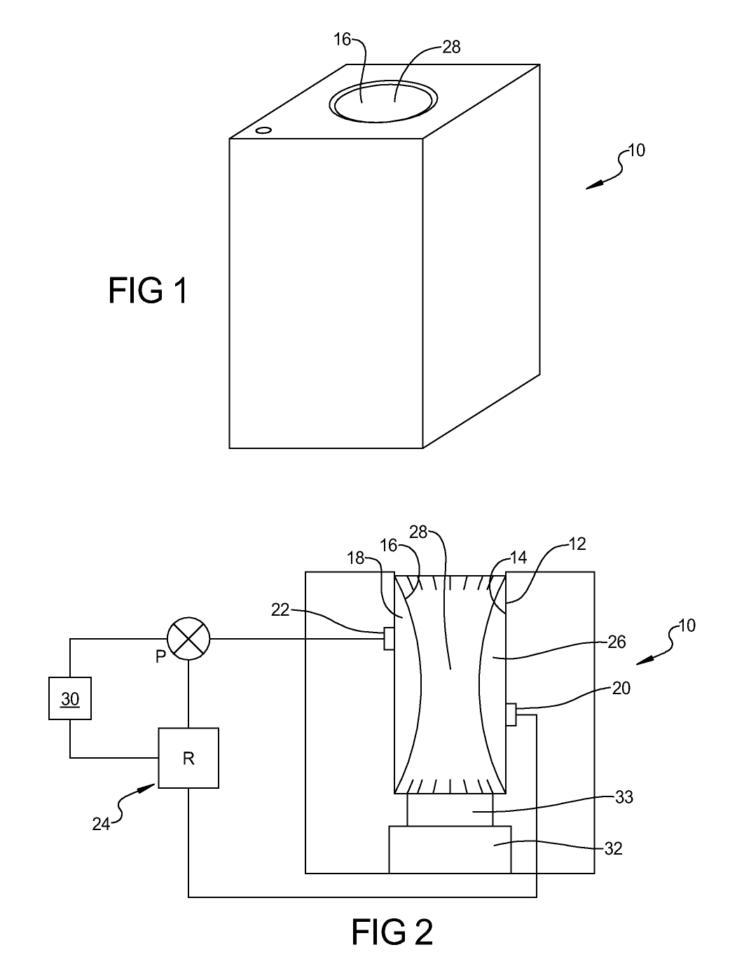

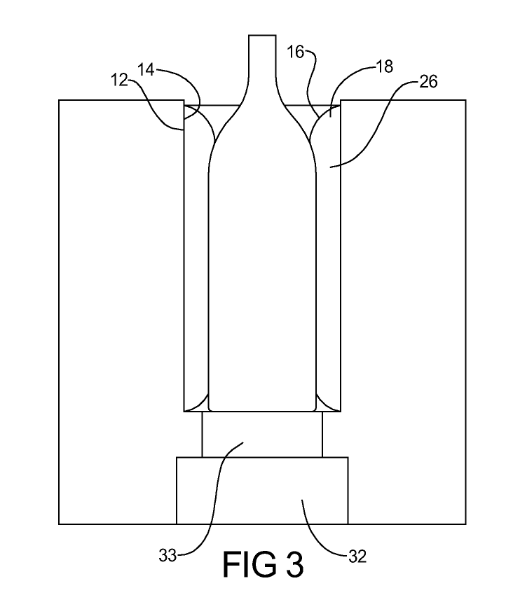

Turning now to the drawings, FIG. 1 illustrates an arrangement for cooling or chilling a beverage in a container such as a bottle or a can, and beverages to be cooled or chilled, such as beer, wine, soda, fruit juices and other fluids to be cooled. The cooling or chilling apparatus 10 includes an elongated cylindrical tube 12 having opposed ends and an inner tubular surface 14, at least one of the ends being open. The tube 12 is formed from a resilient material, such as a metal or a polymer. Preferably the tube 12 is formed from PVC. A membrane 16 is secured about the inner tubular surface 14 to form a sealed enclosure 18 with the tube 12. The enclosure 18 includes an inlet port 20 and an outlet port 22. The apparatus 10 further includes means for circulating 24 a fluid 26 into and out of the enclosure 18 through the respective inlet and outlet ports, 20 and 22, as well as means for vibrating the object when the object is placed within the cylindrical tube 12.

Importantly, it is noted that the chilled fluid 26 is distributed via a closed loop circuit that prevents exposure of the chilled fluid 26 to the atmosphere or to the product being chilled.

The means for circulating 24 comprises a refrigeration system “R” and fluid pump “P” which are conventional and will not be described in detail. In general, the refrigeration system includes cooling coils and a thermostat. The fluid pump draws heated fluid 26 from the tank via the outlet port 22 and into the refrigeration system, and the coils then cool the discharged fluid 26. The fluid pump then passes the fluid 26 that has been cooled to a desired preset temperature and directs this chilled fluid 26 into the inlet port 20. As will be described herein below, this cooled fluid 26 in then passed into the enclosure 18.

Preferably, the refrigeration system operates to maintain the temperature of the chilled fluid 26 at a temperature of between about −30.0° C. and about 5.0° C.

While many suitable liquids are known, preferably the chilled fluid 26 comprises a liquid having a low freezing point, and more preferably it is a solution containing food-quality glycol. The cooling or chilling liquid is preferably a solution of propylene glycol and water of 50% concentration, or brine.

The membrane 16 comprises a body of resiliently deformable material, preferably preformed into a sleeve or shaped bladder. The membrane 16 is torus-shaped in that it abuts and surrounds the inner cylindrical surface 14 of the cylindrical tube 12, and defines internally thereof an internal chamber 28 for receiving, encircling and supporting the beverage container “B” to be chilled. The membrane 16 is generally longitudinally elongated, thin-walled, and centered about a central geometrical longitudinal axis.

Desirably, the membrane 16 enables a wine bottle to be chilled without ever being exposed to the chilled fluid 26.

While many materials are suitable, the membrane 16 is preferably a thermoplastic material, and preferably, thermoplastic polyurethane, and wherein the membrane 16 comprises a thickness of about 0.125 mm.

In the embodiments illustrated, the material of the membrane 16 is preferably thermoplastic polyurethane (TPU) and like materials as providing a combination of high elongation and wear and tensile strength tear-cut resistance and toughness and form a bridge between rubber polymers and thermoplastics. Further, these materials are soft, resiliently flexible, have good low temperature flexibility as well as excellent resistance to solvents and chemicals. Additionally, these materials provide excellent damping, rebound and elasticity characteristics, such as providing increased elastic memory, providing good stretch from 2-6 times with endurance and elasticity. Stretch according to the thickness elasticity keeps in normal condition from +70° C. to −35° C.

An example of a suitable TPU is the Elastollan® brand TPU from BASF, based in Wyandotte, Mich.

The present invention can include the means for controlling 30. The means for controlling 30 can comprise items such as electrical circuitry and at least one timer for controlling the timed sequence operation of the fluid pump and the means for vibrating 32.

The means for vibrating 32 can comprise a vibration plate capable of operating through a wide range of vibration. When a vibration plate is used, a puck 33 having an upper surface which is dimensioned to receive the bottom of a bottle can be placed atop the vibration plate. It is noted that the rate of vibration should be sufficient to agitate the beverage to aid in the heat transfer from the beverage to the fluid 26, yet not so much as to overly disturb the beverage.

The present invention can optionally include an infra red (IR) sensor (not shown) to detect the temperature of the beverage container. The sensor provides a non-contact, non-destructive test method that utilizes a thermal imager to detect, display, and record thermal patterns and temperatures across the surface of the wine bottle, or other object of interest. Infrared thermography provides the user with meaningful data about thermal condition of the bottle being chilled.

The means for controlling 30 can also optionally include an electrical circuit in relation with the IR sensor to ensure that the refrigeration system is properly supplying chilled fluid 26 and that the fluid temperature in the enclosure 18 is maintained at a desired temperature and to indicate when a desired bottle temperature has been achieved. The IR sensor can also enables temperature control feedback on the chilling operation.

As will be understood, the geometry of the internal chamber 28 may be other than shown for dimensional control of the membrane 16 as well as functional operation.

Additionally, the means for controlling 30 can be optionally provided with software or hardware procedures wherein the means for controlling 30 can be set to operate the apparatus 10 to chill a particular beverage to a preset temperature, e.g., 13° C. for red wine or 7° C. for white wine, aced upon input provided by the user.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto and the equivalents thereof.

Having, thus, described the invention what is claimed is:

1. A cooling apparatus for chilling an object comprising:
an elongated cylindrical tube having opposed ends and an inner tubular surface, at least one of the ends being open;
a membrane secured about the inner tubular surface forming a sealed enclosure with the tube, the enclosure having an inlet port and an outlet port;
means for circulating a fluid into and out of the enclosure through the respective inlet and outlet ports; and
means for vibrating the object when the object is placed within the cylindrical tube.

2. The cooling apparatus of claim 1 wherein the membrane is an enclosed bladder.

3. The cooling apparatus of claim 2 wherein the means for vibrating comprises a vibration plate.

4. The cooling apparatus of claim 2 wherein the means for circulating comprises a fluid pump and a refrigeration unit in fluid communication with the enclosure, the refrigeration unit configured to cool the fluid to a set temperature, and the fluid pump configured to pump the fluid from the refrigeration unit to the enclosure.

5. The cooling apparatus of claim 3 wherein the means for circulating comprises a fluid pump and a refrigeration unit in fluid communication with the enclosure, the refrigeration unit configured to cool the fluid to a set temperature, and the fluid pump configured to pump the chilled fluid from the refrigeration unit to the enclosure.

6. The cooling apparatus of claim 5 comprising means for controlling, the means for controlling including electrical circuitry and a timer to control the operation of the fluid pump and the means for vibrating.

7. The cooling apparatus of claim 3 comprising means for controlling, the means for controlling including electrical circuitry and a timer to control the operation of the fluid pump and the means for vibrating.

8. The cooling apparatus of claim 4 comprising means for controlling, the means for controlling including electrical circuitry and a timer to control the operation of the fluid pump and the means for vibrating.

9. The cooling apparatus of claim 6 wherein the membrane comprises a thermoplastic polyurethane elastomer.

10. The cooling apparatus of claim 6 wherein the fluid is selected from a group consisting of a glycol, a mixture of glycol and water, and brine.

11. The cooling apparatus of claim 1 wherein the means for vibrating comprises a vibration plate.

12. The cooling apparatus of claim 11 wherein the means for circulating comprises a fluid pump and a refrigeration unit in fluid communication with the enclosure, the refrigeration unit configured to cool the fluid to a set temperature, and the fluid pump configured to pump the fluid from the refrigeration unit to the enclosure.

13. The cooling apparatus of claim 1 wherein the means for circulating comprises a fluid pump and a refrigeration unit in fluid communication with the enclosure, the refrigeration unit configured to cool the fluid to a set temperature, and the fluid pump configured to pump the fluid from the refrigeration unit to the enclosure.

14. The cooling apparatus of claim 13 comprising means for controlling, the means for controlling including electrical circuitry and a timer to control the operation of the fluid pump and the means for vibrating.

15. The cooling apparatus of claim 1 comprising means for controlling, the means for controlling including electrical circuitry and a timer to control the operation of the fluid pump and the means for vibrating.

16. A method for cooling an object comprising:
providing a cooling apparatus, the cooling apparatus comprising an elongated cylindrical tube having opposed ends and an inner tubular surface, at least one of the ends being open, a membrane secured about the inner tubular surface forming a sealed enclosure with the tube, the enclosure having an inlet port and an outlet port, and means for vibrating the object when the object is placed within the cylindrical tube;
placing the object within the cylindrical tube;
pumping a chilled fluid through the inlet port and into the enclosure to expand and engage the membrane with the object;
circulating the chilled fluid through the inlet port, into the enclosure, and out through the outlet port; and
vibrating the object until the object attains a desired temperature.

17. The method of claim 16 wherein the membrane is an enclosed bladder.

18. The method of claim 16 the means for vibrating comprises a vibration plate.

19. The method of claim 16 wherein the chilled fluid is selected from a group consisting of a glycol, a mixture of glycol and water, and brine.

20. A method of cooling a beverage within a container by engaging the container against a bladder filed with a chilled fluid and vibrating the beverage until the beverage attains a cooled temperature.
